(19) United States
(12) Patent Application Publication
(10) Pub. No.: US 2015/0155668 A1
(43) Pub. Date: Jun. 4, 2015

(54) ADAPTIVE CONNECTOR COLLAR

(71) Applicant: Honeywell International Inc., Morristown, NJ (US)

(72) Inventors: Harold Brian Robinson, Albuquerque, NM (US); Christopher Boyden, Albuquerque, NM (US); John Geruntho, Rio Rancho, NM (US)

(73) Assignee: Honeywell International Inc., Morristown, NJ (US)

(21) Appl. No.: 14/095,409

(22) Filed: Dec. 3, 2013

(51) Int. Cl. H01R 27/00

(52) U.S. Cl. CPC H01R 27/00

(57) ABSTRACT

Embodiments for an adaptive connector collar are provided. In one embodiment, an adaptive connector collar comprises: a cylindrical body having an axial through hole from a first end of the cylindrical body to a second end of the cylindrical body; the first end comprising: a countersink into the cylindrical body defining a first aperture of the axial through hole of a first diameter; an internal shoulder within the axial through hole extending from the first aperture to a second diameter; and internal coupling groves extending from a second aperture of the axial through hole at the second end of the cylindrical body to at least part of a distance to the internal shoulder, wherein the second aperture is larger than the first aperture.

### BACKGROUND

In some environments, electrical components are installed by sliding them into place within a rack or similar structural chassis. Because the electrical connection ports are typically located at the rear panel or the component, and no longer accessible as the component is being installed, blind mating connectors are sometimes utilized to help guide the alignment of male-to-female electrical connections. The problem is that electrical components available in the art today for blind mating connections are significantly more expensive that their industry standard non-blind mating counterpart components. For example, a blind-mate female coaxial connector port is typically an order of magnitude more expensive that a corresponding industry standard Threaded Neill-Concelman (TNC) or Bayonet Neill-Concelman (BNC) female coaxial connector port.

For the reasons stated above and for other reasons stated below which will become apparent to those skilled in the art upon reading and understanding the specification, there is a need in the art for improvements in blind-mate connection designs.

### SUMMARY

The Embodiments of the present invention provide methods and systems for blind-mate connections and will be understood by reading and studying the following specification.

Embodiments for an adaptive connector collar are provided. In one embodiment, an adaptive connector collar comprises: a cylindrical body having an axial through hole from a first end of the cylindrical body to a second end of the cylindrical body; the first end comprising: a countersink into the cylindrical body defining a first aperture of the axial through hole of a first diameter; an internal shoulder within the axial through hole extending from the first aperture to a second diameter; and internal coupling groves extending from a second aperture of the axial through hole at the second end of the cylindrical body to at least part of a distance to the internal shoulder, wherein the second aperture is larger than the first aperture.

### BRIEF DESCRIPTION OF THE DRAWINGS

Embodiments of the present invention can be more easily understood and further advantages and uses thereof more readily apparent, when considered in view of the description of the preferred embodiments and the following figures in which:

FIGS. 1 and 1A illustrate a adaptive connector collar of one embodiment of the present disclosure;

FIGS. 2 and 2A illustrate installation of an adaptive connector collar of one embodiment of the present disclosure;

FIGS. 3 and 3A illustrate a adaptive connector collar of one embodiment of the present disclosure;

FIGS. 4, 4A and 4B illustrate an alternative adaptive connector collar of one embodiment of the present disclosure; and

FIGS. 5A and 5B illustrate a system comprising an adaptive connector collar of one embodiment of the present disclosure.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present disclosure provide an adaptive collar designed to mate to industry standard connector ports in order adapt the connector ports for use in blind mate applications. Embodiments of the adaptive collars described herein are also reversible, meaning that after a device has been fitted for use in blind mate connections, the adaptive collar can be easily removed to re-render the device usable with industry standard connections. Further, a manufacturer utilizing the embodiments described herein can produce a single electrical device design for which units can be sold to both clients needing industry standard connector ports and those needing blind-mate connector ports. For example, an adaptive collar may be included with all units and simply discarded by clients who only need industry standard connector ports. Although the embodiments described herein are primarily illustrative of adaptive collars for use in converting industry standard BNC and TNC female coaxial connectors, those of ordinary skill in the art that study the description and drawings provided herein would appreciate that additional embodiments drawn to converting other standard connector ports for use as blind-mate ports are enabled.

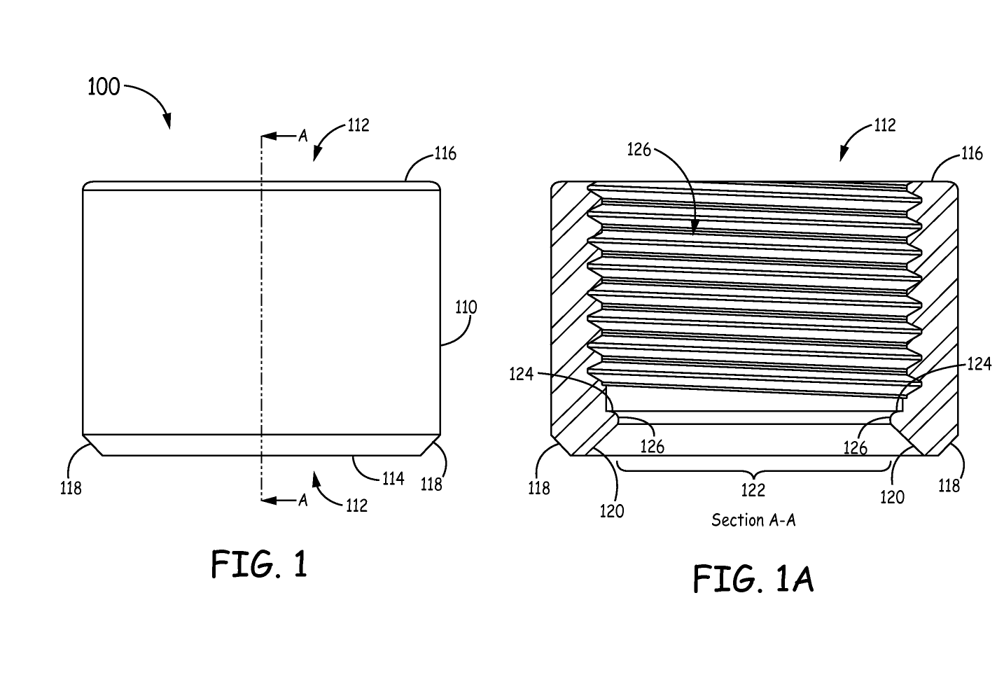

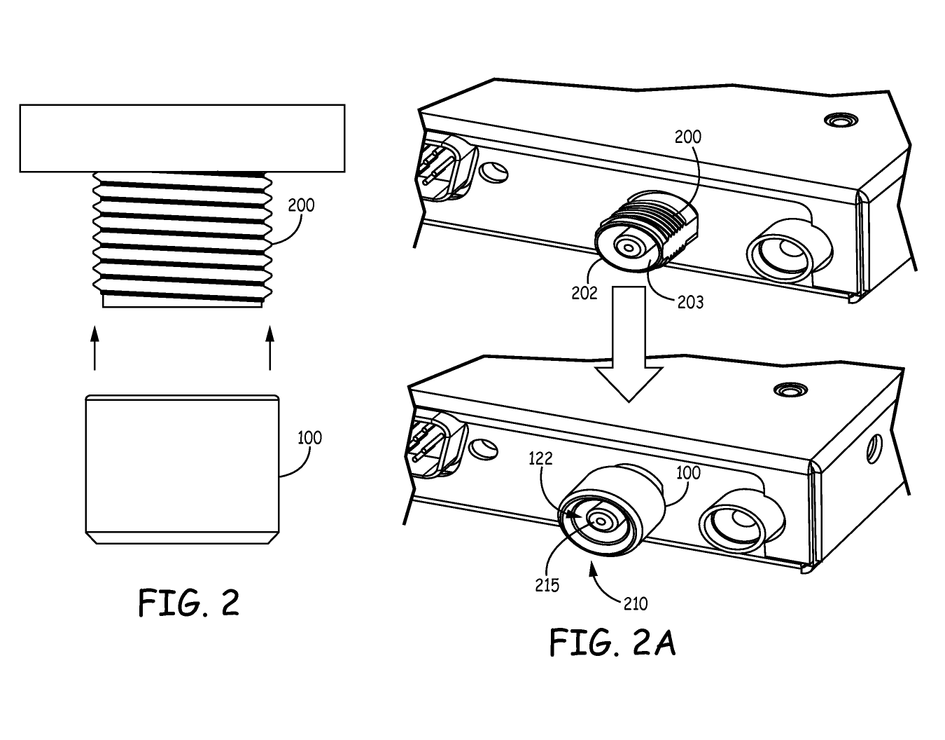

Referring to FIGS. 1, 1A, 2, and 2A, a blind mating adaptive connector collar 100 of one embodiment of the present disclosure is illustrated. Illustrated by a top view in FIG. 1 and a cross-sectional view A-A in FIG. 1A, the adaptive connector collar 100 comprises a cylindrical body 110 having a first end 114 and a second end 116. An axial through hole 112, co-center with the axis of cylindrical body 110, extends from the first end 114 to the second end 116. First end 114 comprises an optional chamfer 118 around the outer circumference of cylindrical body 110. For example, chamfer 118 may be useful in some applications to provide adequate clearance with other components. In other embodiments, chamfer 118 may be excluded. First end 114 also comprised a countersink 120 that extends into the cylindrical body 110 to the through hole 112 to define a first aperture 122 into through hole 112. An internal shoulder 124 within the axial through hole 112 extends from the edge 126 of the first aperture 122 into the cylindrical body so that the balance of the through hole 112 from the shoulder 124 to the second end 116 has a diameter greater than that of the first aperture 122. Internal mating groves 126 extend from a second aperture 128 of the axial through hole 112 at the second end 116 of the cylindrical body 110 at least part the way to the internal shoulder 124. For the particular embodiment illustrated by FIG. 1A, the internal mating groves 126 comprise internal machine threads extending from the second aperture at least part of the way to the internal shoulder 124. This embodiment is thus appropriate for converting a threaded connector port, such as a female TNC to a blind-mate connector port as illustrated by FIGS. 2 and 2A. In FIGS. 2 and 2A, adaptive connector collar 100 is installed over a female TNC port 200 by mating the internal machine threads within the threads of TNC port 200 and rotating the adaptive connector collar 100 until it is secure. The result is as shown generally at 210, where the female receptor 215 is exposed and centered within aperture 122 of the collar 100. In one embodiment, the lip 202 of TNC port 200 will abut against internal shoulder 124. Further the first aperture 122 is dimensioned such that there is a smooth transition at aperture 122 from countersink 120 to the inner surface 203 of the lip 202.

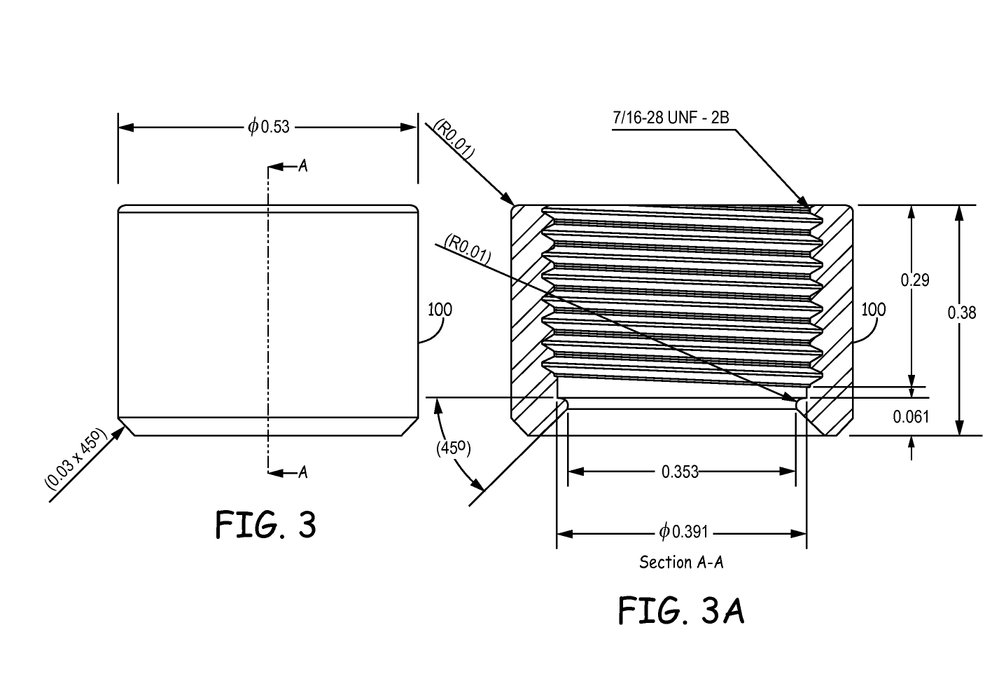

FIGS. 3 and 3A illustrate a particular implementation of an adaptive connector collar 300 such as described above which may be utilized to convert a standard TNC coaxial port to a blind mating port. Certain specifications and dimensions, such as the internal machine threads specified as 7/16-28 UNF-2B, the first aperture having a diameter of 0.353 inched, and the internal shoulder extending from the diameter of 3.353 inches to a second diameter of 0.391 inches, would be dictated by the standard dimensions of the port to which the adaptive connector collar 300 would be mated. Other dimensions, such as the angle of the countersink 310 or angle of chamber 320, may be adjusted to accommodate alignment tolerances.

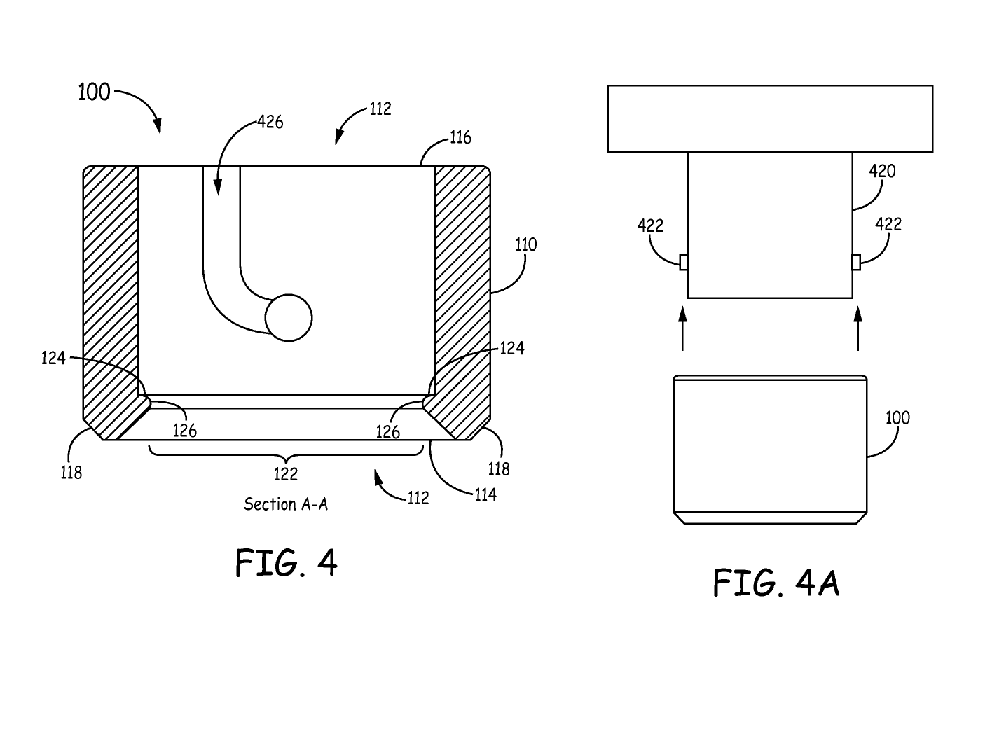

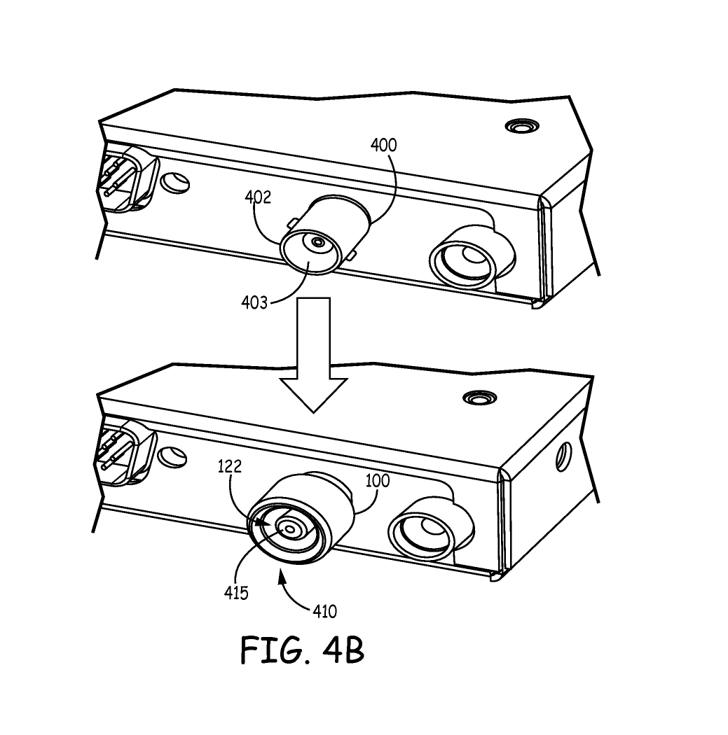

FIGS. 4 (shown in the cross sectional view), 4A and 4B illustrate an alternate embodiment of an adaptive connector collar 100. As shown in the cross sectional view of FIG. 4, the internal coupling groves 126 are instead shaped as slots 426 compatible with mating with the two bayonet lugs 422 of a standard female BNC connector 420. In this case, mating of the collar 400 to the female BNC connector 420 is achieved with only a quarter turn of the collar 400 when the bayonet lugs 422 are inserted into the slots 426. In some embodiments, a preload spring may be incorporated within adaptive connector collar 100 to keep adaptive connector collar 100 mated with BNC connector 420 and retain bayonet lugs 422 within slot 426. The result is as shown in FIG. 4B generally at 410, where the female receptor 415 is exposed and centered within aperture 122 of the collar 100. In one embodiment, the lip 402 of BNC port 400 will abut against internal shoulder 124. Further the first aperture 122 is dimensioned such that there is a smooth transition at aperture 122 from countersink 120 to the inner surface 403 of the lip 402.

In any of the embodiments described herein, the material used for fabricating the adaptive connector collar may vary to accommodate a particular application and is not critical for accomplishing a blind mate connection. For example, in one embodiment, the body of the adaptive connector collar is machined or otherwise fabricated from metal materials. In other embodiments, composite materials, plastics, nylons, or still other materials may be used. For applications where electrical isolation of the connector ports within the collar from the external environment is desired, the adaptive connector coupled may be fabricated from non-conducting materials. For embodiments where a metal adaptive connector collar is desired, the metal may be selected to be chemically compatible with the material of the port to which it is being installed.

Further, although the adaptive connector collar is described as comprising a cylindrical body, it should be understood that term encompasses tubular shapes where one or more portions of the external surface are flat. For example, in one embodiment, an adaptive connector collar may comprise a pair of planar surfaces on opposing sides that accommodate using a wrench for tightening the collar. In still other embodiment, the exterior surface of the cylindrical body may be hexagonal, or octagonal, for example.

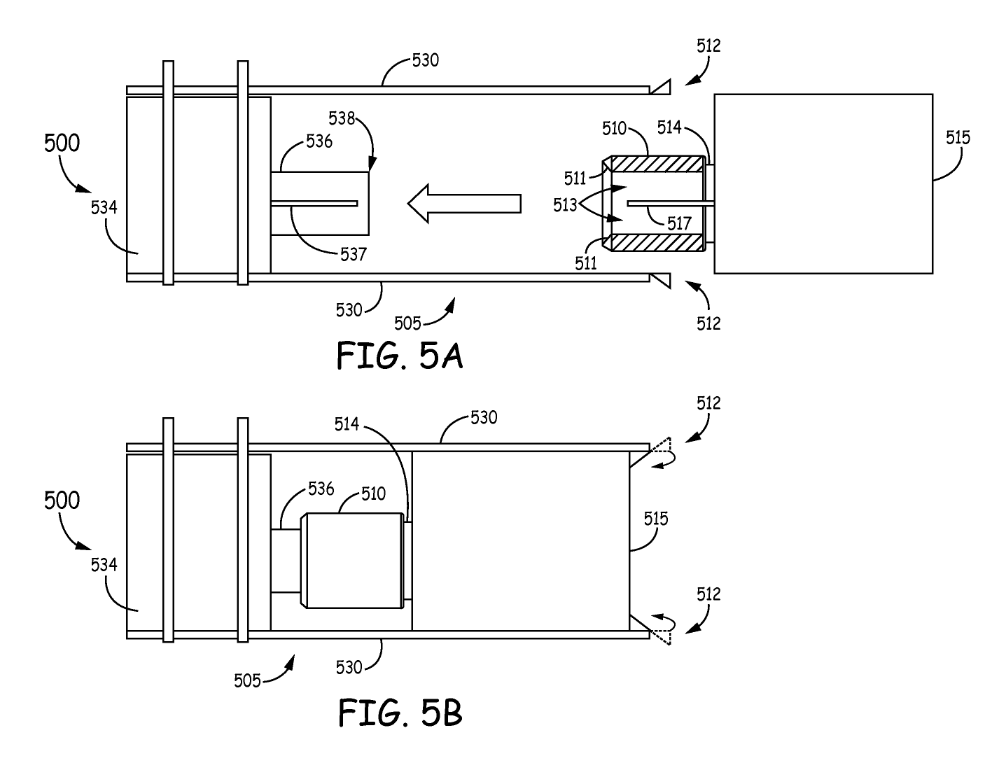

FIGS. 5A and 5B are block diagrams illustrating a system 500 incorporating an adaptive connector collar 510, such as any of the collars described above. In this embodiment, system 500 comprises a system rack 505 and an electrical component 515, which is a modular device which is intended to be easily installed into system rack 505 by insertion. Electrical component 512 comprises an industry standard female co-axial port 514 converted for blind-mating applications by adaptive connector collar 510 (shown in cross section in FIG. 5A). For example, in some embodiments, co-axial port 514 may either be a BNC or TNC standard port. In other embodiments, another standard port type may be utilized. Adaptive connector collar 510 includes the appropriate internal mating groves for mating collar 510 to co-axial port 514.

System rack 505 further comprises a chassis 530 into which electrical component 515 is installed. As illustrated at FIG. 5A, electrical component 515 is installed by insertion into chassis 530. In one embodiment, there is a designated rack position or slot 532 in chassis 530 where electrical component 515 is installed. In this designated slot 532, chassis 530 supports in place at the rear of slot 532 a second electrical component 534. Second electrical component 534 comprises a blind-mate male coaxial port 536 oriented to point towards the front of slot 532 to facilitate mating with female co-axial port 514 (shown in cross section in FIG. 5A). Adaptive connector collar 510 facilitates this mating of male coaxial port 536 with female coaxial port 514. In operation, as electrical component 515 is installed by insertion into chassis 530 at slot 532, a lip 538 of blind-mate male coaxial port 536 will contact the countersink 511 of adaptive connector collar 510. Since blind-mate male coaxial port 536 is being held relatively ridged (although in some embodiments, may itself be designed to have some float), the pressure of lip 538 against countersink 511 will cause an alignment that guides blind-mate male coaxial port 536 into the open aperture 513 of adaptive connector collar 510 and subsequently to female co-axial port 514. When fully installed, the center conductor 537 of the male coaxial port 536 is inserted into the center conductor receiver 517 of the female co-axial port 514. In one embodiment, once installed as shown in FIG. 5B, electrical component 515 may be secured within chassis 530 by one or more locking mechanisms 540 to maintain connectivity between ports 536 and 514.

### Example Embodiments

Example 1 includes an adaptive connector collar, the collar comprising: a cylindrical body having an axial through hole from a first end of the cylindrical body to a second end of the cylindrical body; the first end comprising: a countersink into the cylindrical body defining a first aperture of the axial through hole of a first diameter; an internal shoulder within the axial through hole extending from the first aperture to a second diameter; and internal coupling groves extending from a second aperture of the axial through hole at the second end of the cylindrical body to at least part of a distance to the internal shoulder, wherein the second aperture is larger than the first aperture. The first end may further optionally comprise a chamfer.

Example 2 includes the collar of Example 1, wherein the internal coupled groves comprise internal machine threads extending from the second aperture to at least part of a distance to the internal shoulder.

Example 3 includes the collar of any of Examples 1-2, wherein the internal machine threads are 7/16-28 UNF-2B.

Example 4 includes the collar of any of Examples 1-3, wherein the first diameter is 3.353 inches and the second diameter is 0.391 inches.

Example 5 includes the collar of any of Examples 1-4, wherein the countersink has an angle of 45 degrees with respect to a plane of the first end.

Example 6 includes the collar of any of Examples 1-5, wherein the internal coupling groves are shaped to mate cylindrical body with a BNC standard female connector.

Example 7 includes the collar of any of Examples 1-6, wherein the cylindrical body is comprised of a metal.

Example 8 includes the collar of any of Examples 1-7, wherein the cylindrical body is comprised of a non-conducting material.

Example 9 includes an electrical device, the device comprising: a female RF coaxial connector port; an adaptive connector collar installed around the female RF coaxial connector port, the collar comprising: a cylindrical body having an axial through hole from a first end of the cylindrical body to a second end of the cylindrical body; the first end comprising: a countersink into the cylindrical body defining a first aperture of the axial through hole of a first diameter; and an internal shoulder within the axial through hole extending from the first aperture to a second diameter; wherein a center conductor receiver of the female RF coaxial connector port is centered within the axial through hole and accessible via the first aperture. The first end may further optionally comprise a chamfer.

Example 10 includes the device of Example 9, wherein the cylindrical body further comprises: internal coupling groves extending from a second aperture of the axial through hole at the second end of the cylindrical body to at least part of a distance to the internal shoulder, wherein the second aperture is larger than the first aperture.

Example 11 includes the device of any of Examples 9-10, wherein the internal coupled groves comprise internal machine threads extending from the second aperture to at least part of a distance to the internal shoulder.

Example 12 includes the device of any of Examples 9-11, wherein the internal machine threads are 7/16-28 UNF-2B.

Example 13 includes the device of any of Examples 9-12, wherein the first diameter is 3.353 inches and the second diameter is 0.391 inches.

Example 14 includes the device of any of Examples 9-13, wherein the countersink has an angle of 45 degrees with respect to a plane of the first end.

Example 15 includes the device of any of Examples 9-14, wherein the internal coupling groves are shaped to mate cylindrical body with a BNC standard female connector.

Example 16 includes the device of any of Examples 9-15, wherein the cylindrical body is comprised of a metal.

Example 17 includes the device of any of Examples 9-16, wherein the cylindrical body is comprised of a non-conducting material.

Example 18 includes a system for electrically coupling two electrical components, the system comprising: a first component comprising a female RF coaxial connector port; a second component comprising a male RF coaxial connector port compatible with the female RF coaxial connector port; and an adaptive connector collar installed around the female RF coaxial connector port, the collar comprising: a cylindrical body having an axial through hole from a first end of the cylindrical body to a second end of the cylindrical body; the first end comprising: a countersink into the cylindrical body defining a first aperture of the axial through hole of a first diameter; and an internal shoulder within the axial through hole extending from the first aperture to a second diameter; wherein a center conductor receiver of the female RF coaxial connector port is centered within the axial through hole and accessible via the first aperture; and wherein the male RF coaxial connector port is mated to the female RF coaxial connector port. The first end may further optionally comprise a chamfer.

Example 19 includes the device of Example 18, wherein the cylindrical body is comprised of a non-conducting material.

Example 20 includes the device of any of Examples 18-19, wherein the cylindrical body comprises internal coupling groves extending from a second aperture of the axial through hole at the second end of the cylindrical body to at least part of a distance to the internal shoulder, wherein the second aperture is larger than the first aperture.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An adaptive connector collar, the collar comprising:
a cylindrical body having an axial through hole from a first end of the cylindrical body to a second end of the cylindrical body;
the first end comprising:
a countersink into the cylindrical body defining a first aperture of the axial through hole of a first diameter;
an internal shoulder within the axial through hole extending from the first aperture to a second diameter; and
internal coupling groves extending from a second aperture of the axial through hole at the second end of the cylindrical body to at least part of a distance to the internal shoulder, wherein the second aperture is larger than the first aperture.

2. The collar of claim 1, wherein the internal coupled groves comprise internal machine threads extending from the second aperture to at least part of a distance to the internal shoulder.

3. The collar of claim 2, wherein the internal machine threads are 7/16-28 UNF-2B.

4. The collar of claim 1, wherein the first diameter is 3.353 inches and the second diameter is 0.391 inches.

5. The collar of claim 1, wherein the countersink has an angle of 45 degrees with respect to a plane of the first end.

6. The collar of claim 1, wherein the internal coupling groves are shaped to mate cylindrical body with a BNC standard female connector.

7. The collar of claim 1, wherein the cylindrical body is comprised of a metal.

8. The collar of claim 1, wherein the cylindrical body is comprised of a non-conducting material.

9. An electrical device, the device comprising:
a female RF coaxial connector port;
an adaptive connector collar installed around the female RF coaxial connector port, the collar comprising:
a cylindrical body having an axial through hole from a first end of the cylindrical body to a second end of the cylindrical body;
the first end comprising:
a countersink into the cylindrical body defining a first aperture of the axial through hole of a first diameter; and
an internal shoulder within the axial through hole extending from the first aperture to a second diameter;
wherein a center conductor receiver of the female RF coaxial connector port is centered within the axial through hole and accessible via the first aperture.

10. The device of claim 9, wherein the cylindrical body further comprises:
internal coupling groves extending from a second aperture of the axial through hole at the second end of the cylindrical body to at least part of a distance to the internal shoulder, wherein the second aperture is larger than the first aperture.

11. The device of claim 10, wherein the internal coupled groves comprise internal machine threads extending from the second aperture to at least part of a distance to the internal shoulder.

12. The device of claim 11, wherein the internal machine threads are 7/16-28 UNF-2B.

13. The device of claim 11, wherein the first diameter is 3.353 inches and the second diameter is 0.391 inches.

14. The device of claim 9, wherein the countersink has an angle of 45 degrees with respect to a plane of the first end.

15. The device of claim 9, wherein the internal coupling groves are shaped to mate cylindrical body with a BNC standard female connector.

16. The device of claim 9, wherein the cylindrical body is comprised of a metal.

17. The device of claim 9, wherein the cylindrical body is comprised of a non-conducting material.

18. A system for electrically coupling two electrical components, the system comprising:
a first component comprising a female RF coaxial connector port;
a second component comprising a male RF coaxial connector port compatible with the female RF coaxial connector port; and
an adaptive connector collar installed around the female RF coaxial connector port, the collar comprising:
a cylindrical body having an axial through hole from a first end of the cylindrical body to a second end of the cylindrical body;
the first end comprising:
a countersink into the cylindrical body defining a first aperture of the axial through hole of a first diameter; and
an internal shoulder within the axial through hole extending from the first aperture to a second diameter;
wherein a center conductor receiver of the female RF coaxial connector port is centered within the axial through hole and accessible via the first aperture; and
wherein the male RF coaxial connector port is mated to the female RF coaxial connector port.

19. The system of claim 18, wherein the cylindrical body is comprised of a non-conducting material.

20. The system of claim 18, wherein the cylindrical body comprises internal coupling groves extending from a second aperture of the axial through hole at the second end of the cylindrical body to at least part of a distance to the internal shoulder, wherein the second aperture is larger than the first aperture.
